(19) United States
(12) Patent Application Publication
(10) Pub. No.: US 2004/0032157 A1
(43) Pub. Date: Feb. 19, 2004

(54) Restraint bar for securing a person in vehicles, especially for amusement rides

(76) Inventor: Michael Trimborn, Hanau (DE)

Correspondence Address: Thomas M Freiburger, 650 California Street 25th Floor, San Francisco, CA, 94108, US

(21) Appl. No.: 10/240,455

(22) PCT Filed: Oct. 11, 2001
(86) PCT No.: PCT/EP00/10783

(51) Int. Cl. A47D 15/00

(52) U.S. Cl. 297/484

(57) ABSTRACT

The invention relates to a restraint bar for securing a person in vehicles, especially for amusement rides. Said restraint bar is hinged at the top end of a seat and the end of the restraint bar opposite the hinge can be folded up to allow a person to board and get off. The bar can be lowered onto the shoulder and breast side of the person for the purpose of securing the person. The inventive restraint bar is associated with auxiliary bars (2) that are fastened to the restraint bar and that can be introduced with their free ends in a plane below the zone of the restraint bar facing the shoulders, thereby allowing the restraint bar to be used also for smaller persons, especially for children. In a second embodiment, the hinge of the restraint bar can be vertically displaced relative to the seat.

The invention concerns a restraint bar for securing persons in vehicles, especially amusement rides, in accordance with the precharacterizing clause of claims 1 or 8.

In vehicles for street traffic, the persons to be transported are normally secured with safety belts in the form of two-point or three-point belts. Also known are four- or five-point belts that provide increased safety against lateral movements. However, these types of belt systems are usable only for securing persons that move in a constant plane.

In amusement cars such as are found at annual fairs or in leisure parks, it is indeed also possible to make use of belt securing systems when the vehicles also move in one plane. However, other factors are to be taken into account here that are not of importance in vehicles for street traffic. For example, belt systems are moisture sensitive so that they cannot be used in vehicles exposed to the weather. Whenever vehicles or gondolas in amusement rides move in several planes, belt type securing systems do not suffice for guaranteeing safety. This applies, for example, in figure-eight rides, loop-the-loop arrangements and similar amusement rides. Therefore, distributed about in recent years for this purpose have been securing systems that display solid restraint bars, that are associated in pivoted fashion with the passenger seat, and that enable a mechanically solid securing of the passengers. These types of restraint bars are also associated with control devices that detect whether the lock of the restraint bar is actually closed. These types of restraint bars can be opened only when the travel of the amusement ride is ended. The passenger is held safely in the seat even without his active support, so that even in the case of unforeseeable lateral or looping situations the securing function remains guaranteed.

The known restraint bars are, in particular, supported in a swivel joint at the upper end of a seat, whereby the end of the restraint bar lying opposite the swivel joint is swingable upwardly for a person to climb in or climb out, and, for securing the person, can be lowered onto the shoulder or the breast side of the person. For increasing comfort, the restraint bars are, as a rule, covered over with synthetic-material padding.

Since the size of the restraint bar is invariable, these types of bars are usable only for a certain variation in range in the sizes of persons. In the case of very large persons they are squeezed by a too small restraint bar, while for small persons or children no securing of the shoulder area can be guaranteed. Therefore, use of these types of restraint systems is authorized through the National Supervisory Institutions only in the case of persons above a certain age. For smaller persons or children, for example less than 1.27 m tall, special children's seats must be provided, if children are allowed at all in such amusement installations.

The object of the invention is to provide a restraint bar for securing a person in vehicles, especially for amusement rides, that can be used for a greater variation in range of person sizes, but at the same time, guarantees greater safety and enables comfortable manipulation.

This object is resolved by the invention indicated in claims 1 or 8. Advantageous developments of the invention are given in subclaims.

In the case of the species indicated in the precharacterizing clause of claim 1, in accordance with the invention associated with the restraint bar are one or two auxiliary bars that are fastened on one side to the restraint bar and that can be introduced with their free ends into a plane below the zone of the restraint bar facing the shoulders.

In the case of the invention indicated in claim 8, the restraint bar is displaceable in the vertical direction relative to the seat.

Through the inventive measure according to claim 1, it becomes possible, by extending or swinging out the auxilliary restraint bar, to form a shoulder support, which in the active state is located below the shoulder support formed by the restraint bar. In this way, children shorter than 1.27 m can also be held firmly and safely in the seat.

The restraint bar is preferably formed as a U-shaped frame whose free ends are supported in swivel joints on both sides of the head area of the seat. The auxiliary bars can, in particular, be executed in the form of telescoping guides that are attached to the arms of the U-shaped frame. In the state of rest of the telescoping guides a restraint bar of the inventive type is not differentiated from the function of a restraint bar of the known type. It is only when the auxiliary bars are extended out from the telescoping guides that there results a new shoulder-pressing plane. The restraint bar of the inventive type is, therefore, usable as a traditional restraint bar as well as a special restraint bar for small persons. It can be used on any seat of amusement rides, without different retaining bars needing to be provided for different size persons.

The telescoping guides are, in particular, formed arc-shaped, whereby the auxiliary bars are formed of two arc-shaped rods, which in the state of rest are pushed back into the telescoping guides, while in the extended state they form two lateral arc-shaped supports on the person's shoulders.

In an alternative development the auxiliary bar can also be mounted at a joint of the restraint bar, so the it can pivot in the seat region of the restraint bar and thus form an additional shoulder support plane.

In another development of the invention according to claim 8, the restraint bar can be displaced in its vertical direction, in its entirety, relative to the seat.

The restraint bar is here preferably constructed in multipart fashion, with the transverse arm section being joined telescopically with the longitudinal arm of the restraint bar.

By synchronous opposite displacement of the transverse arm section relative to the displacement of the restraint bar, essentially only the shoulder section of the restraint bar is lowered, in order thereby to better secure small persons.

Preferably, the restraint bar and optionally the auxiliary bar display pressure pads that are preferably formed as a cushioning pad on the sides pressing against the person. The cushioning pads can be air-filled chambers; they can also be constructed as fluid-filled hollow chambers, whereby preferably a viscous gel is capable of being used as the fluid.

The restraint bar is further preferably provided with outwardly directed arc-shaped handles onto which the person can additionally hold tight. Since these handles consist essentially of metal, provision can be made so that they are also electrically heated in order to counteract cramping of the person's fingers.

Actuation of the auxiliary bars is done, in particular, pneumatically.

Preferably, located in the shoulder section of the restraint bar is at least one distance sensor that, when determining that the shoulder height of a person is below a set point value, triggers a control signal for actuation of the auxiliary bars or the displacement of the restraint bar and/or of the transverse arm section. As soon as a person sits in the seat, the shoulder height is therewith determined via the distance sensor. When this height is below a set point value, the sensor emits a signal that triggers activation of the auxiliary bars or the displacement.

Achieved in this manner is that a completely automatic fitting of the restraint bar to the size of the person is attainable.

Preferably, the sensor is a capacitive sensor in order to exclude false signals.

When the trip with an amusement ride is ended, normally the restraint bar is disconnected. Preferably, simultaneously with release of the restraint bar out from the locked position there also results resetting of the auxiliary bars or resetting of the lower displacement means into the at-rest position.

The invention permits holding persons firmly and safely in seats, even when they are very different in size. Therewith, in particular also children can use the amusement ride without danger.

The system in accordance with the invention is usable not only in amusement rides but can also be used in any type of vehicles in which a high degree of safety is required.

The invention will be explained in more detail in the following using examples of embodiment. Shown are:

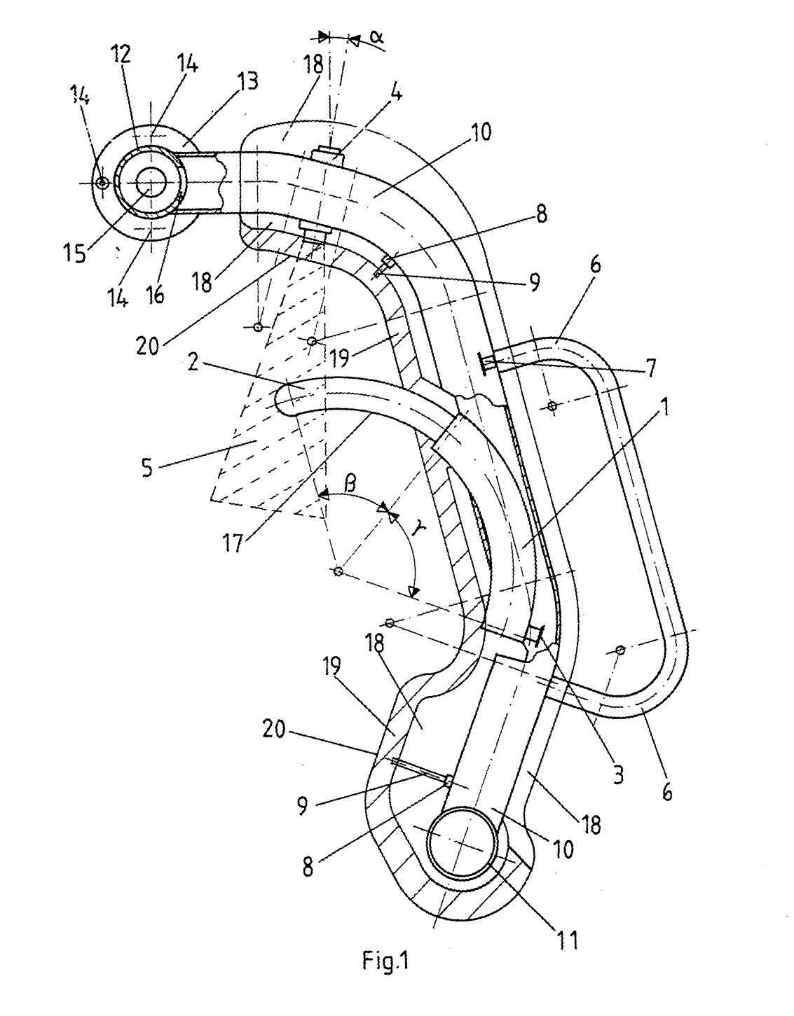

FIG. 1 a side view of a restraint bar where an auxiliary bar is extended,

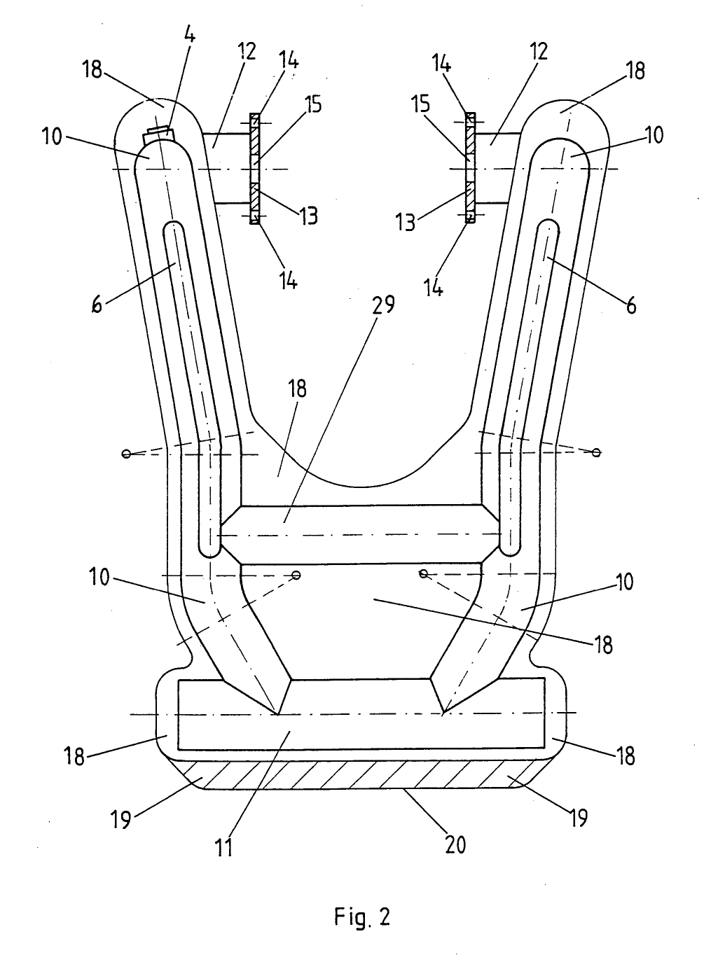

FIG. 2 A view of FIG. 1 from the front side,

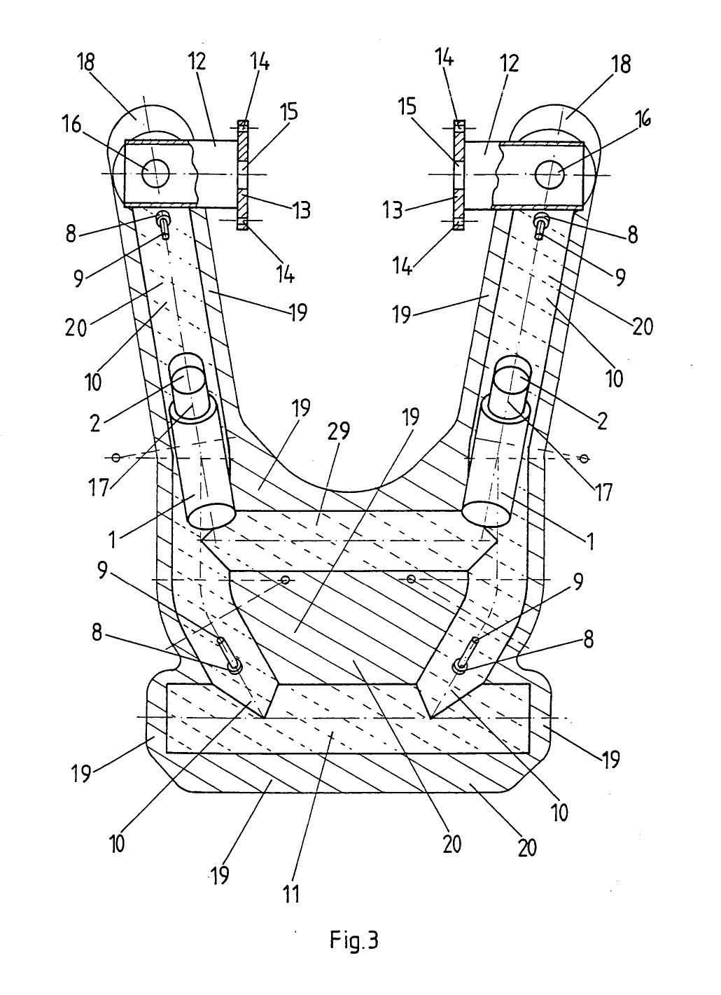

FIG. 3 A rear view of a restraint bar with a representation of the auxiliary bar,

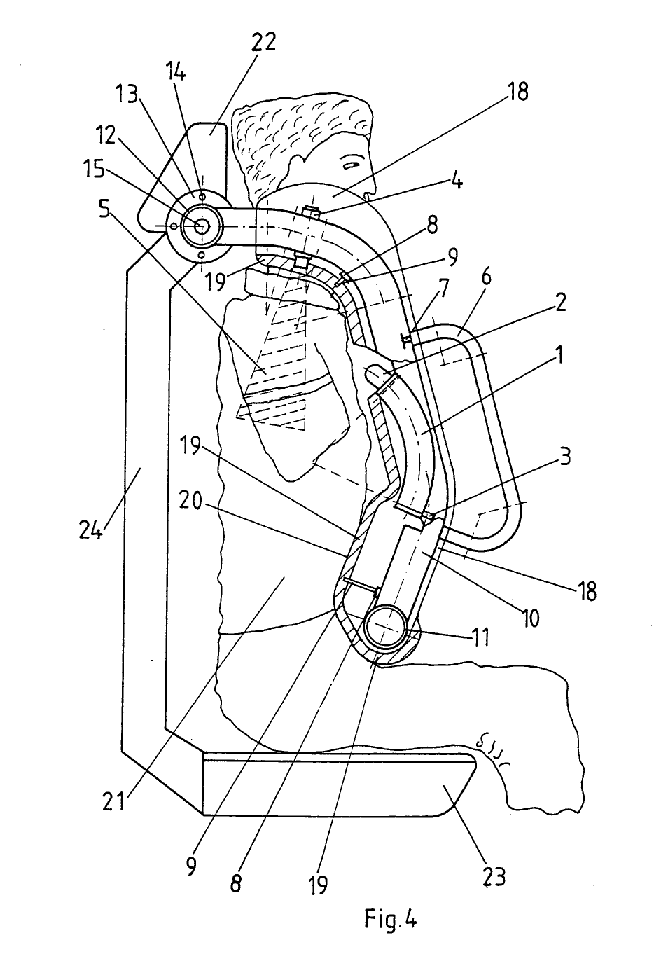

FIG. 4 a seat with restraint bar where an auxiliary bar is retracted,

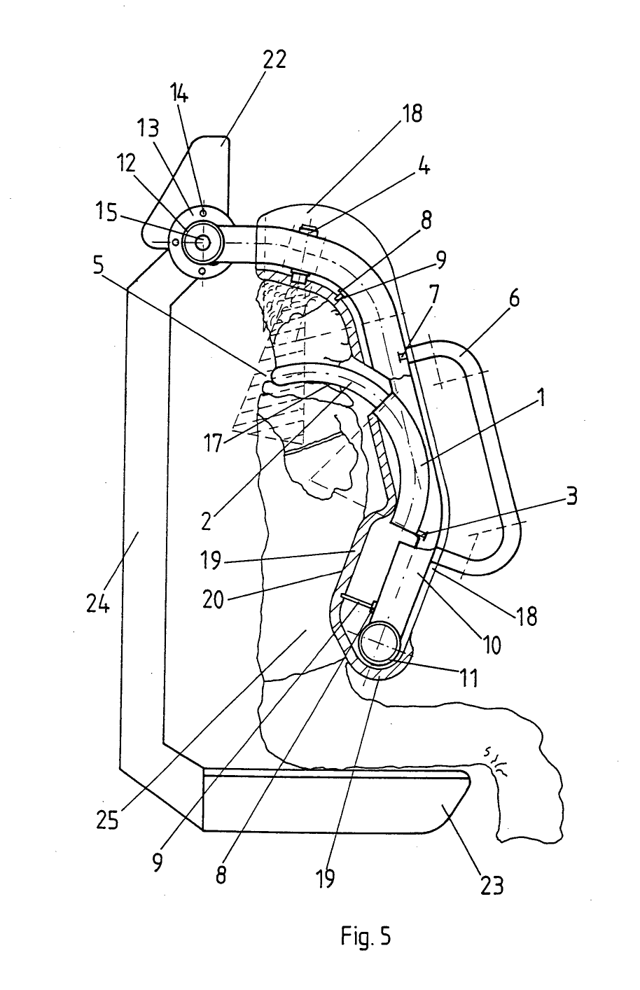

FIG. 5 a seat with restraint bar where the auxiliary bar is extended,

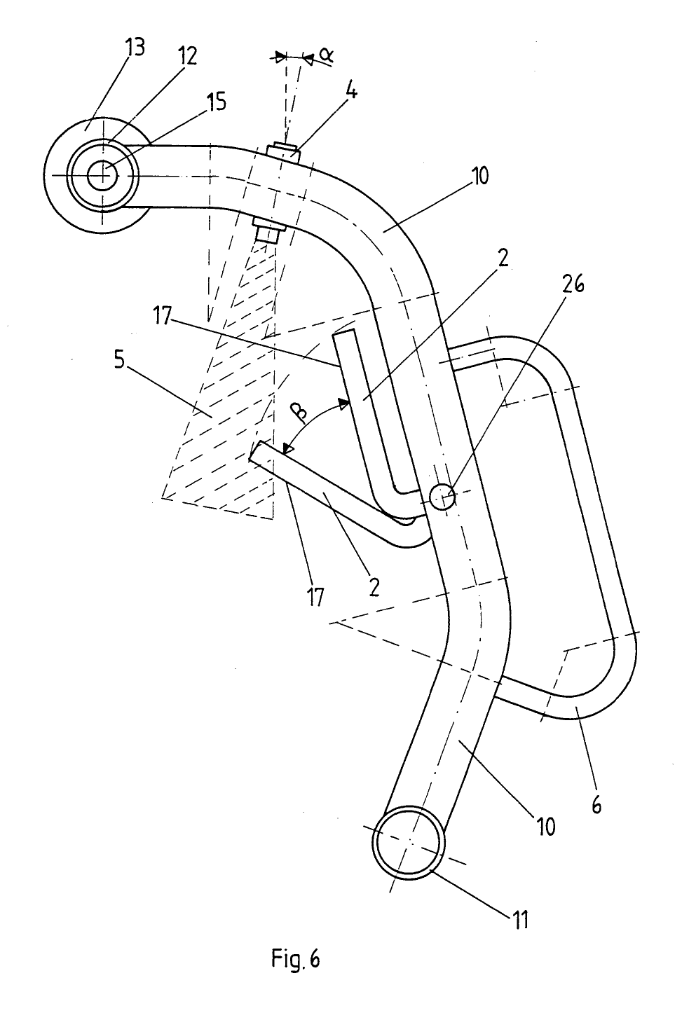

FIG. 6 an alternative form of embodiment with a swingable auxiliary bar,

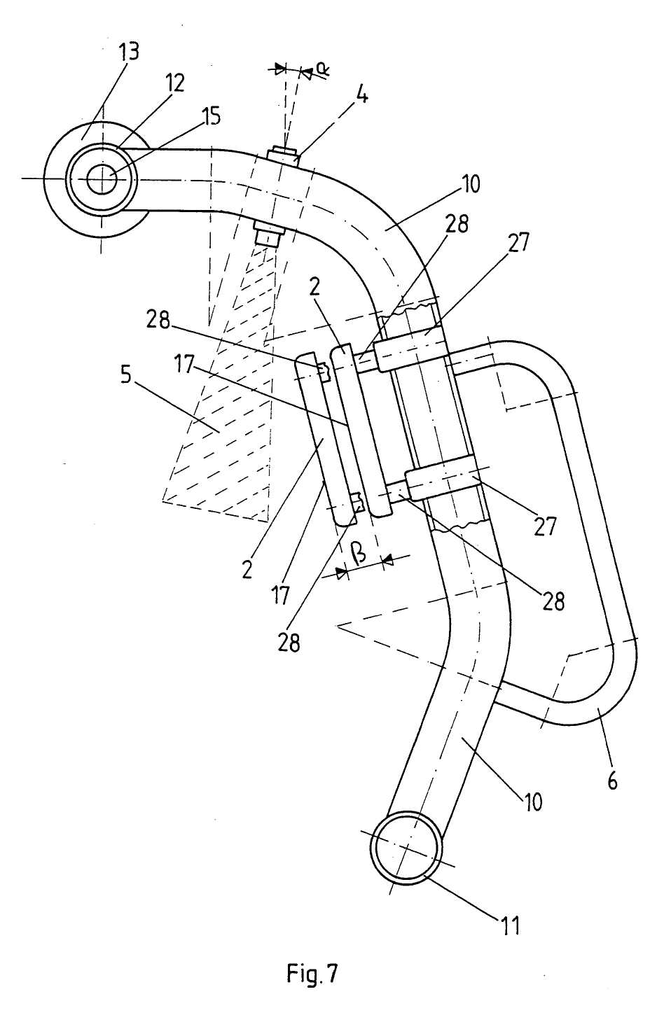

FIG. 7 yet another alternative form of embodiment where the auxiliary bar is replaced by a pressure strip,

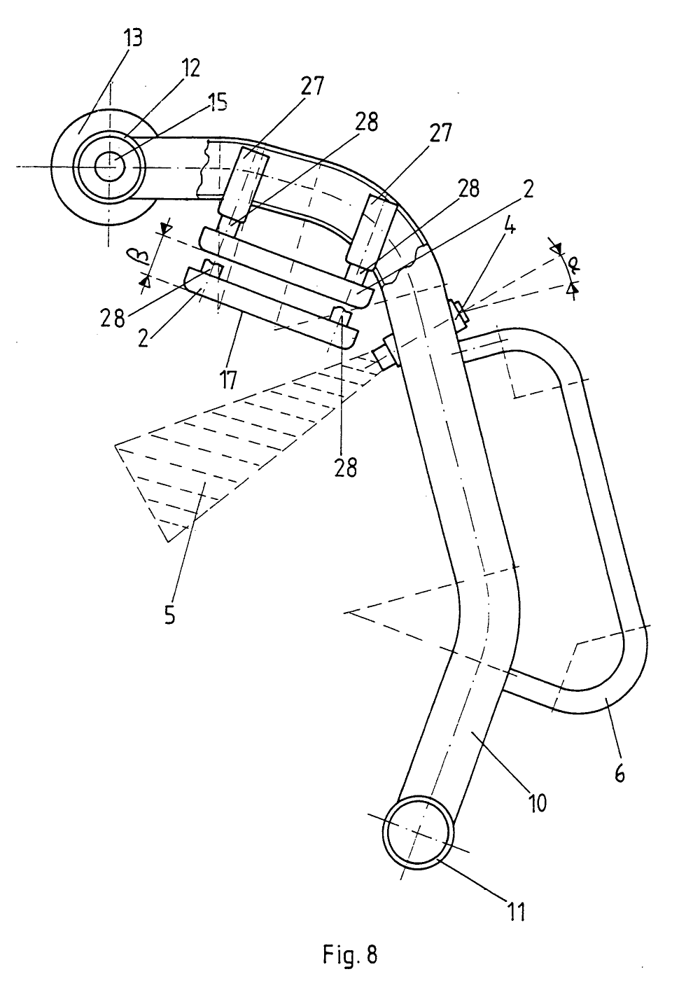

FIG. 8 a restraint bar where the restraint bar is replaced or complemented by a pressure strip arranged in the shoulder section,

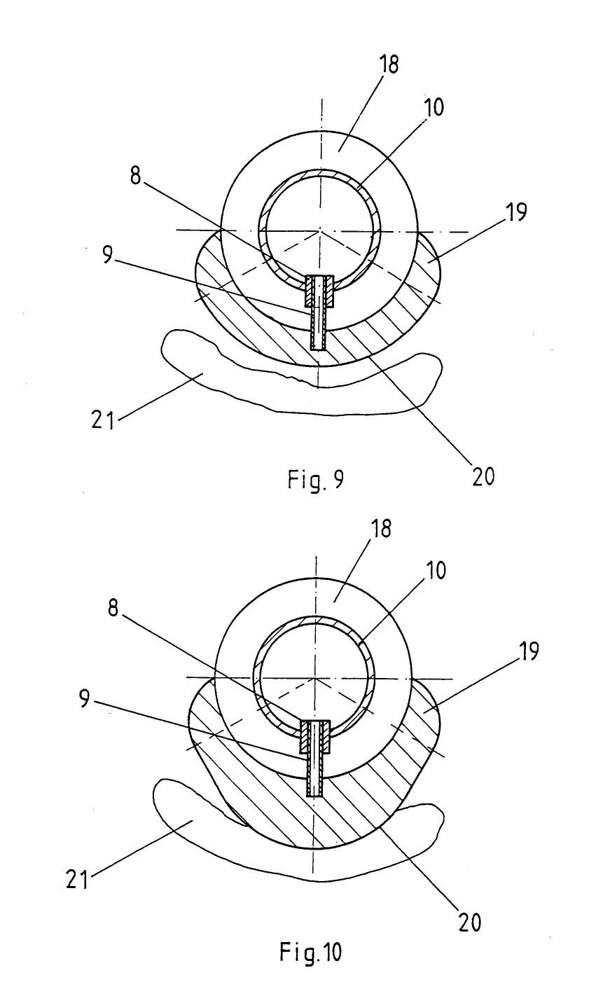

FIG. 9 a section of a retaining bar with a representation of the padding in the non-active condition,

FIG. 10 a section of a retaining bar with padding, in an activated view,

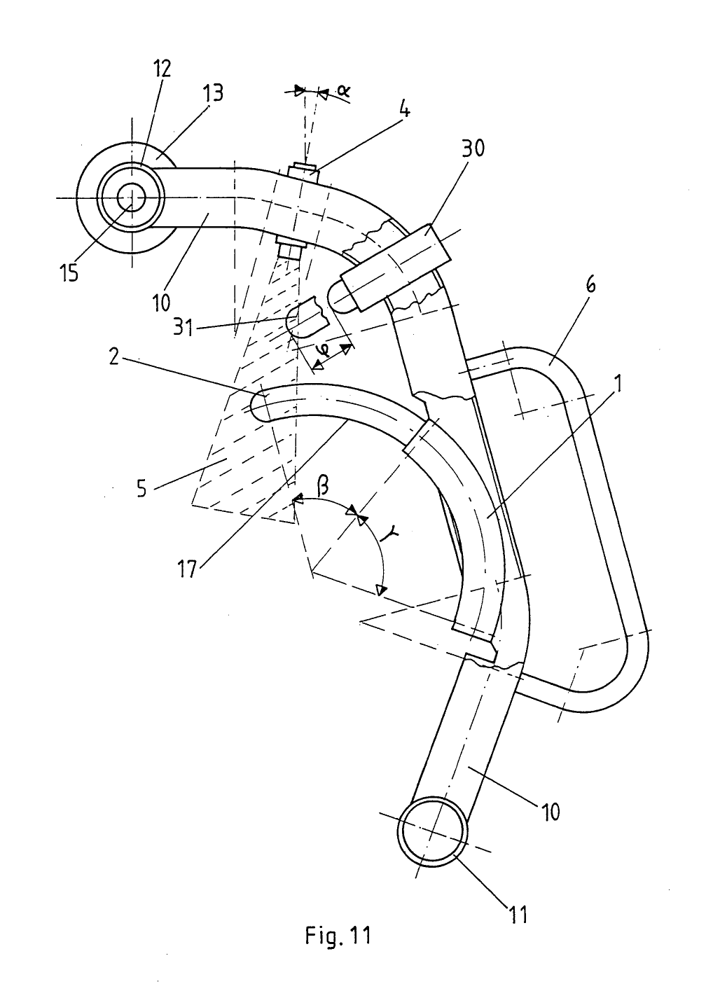

FIG. 11 a side view of a restraint bar with extendible padding,

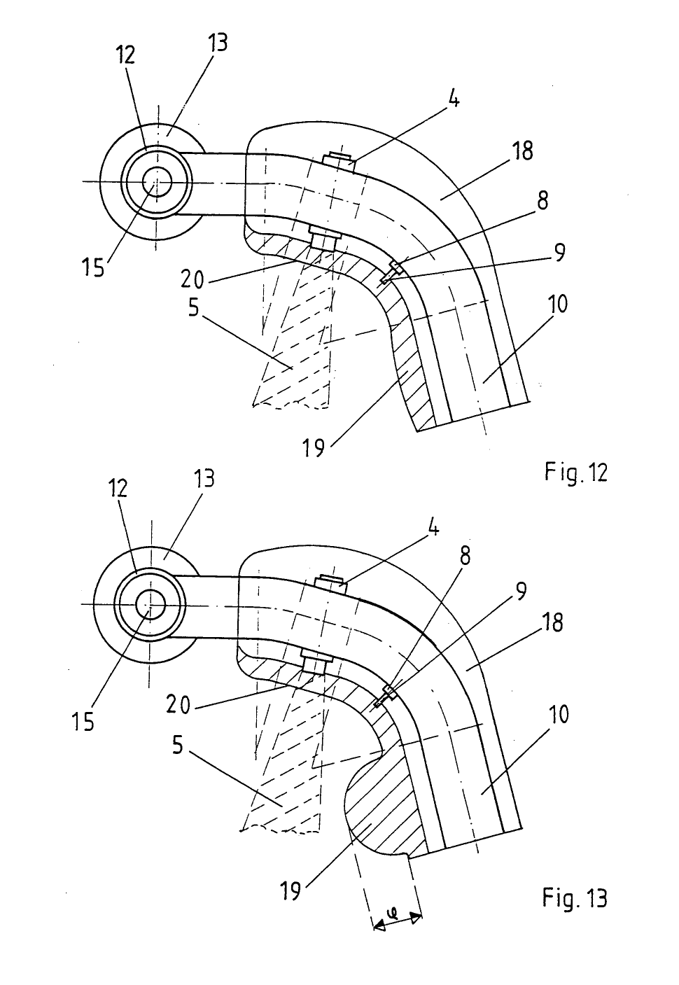

FIG. 12 a side view of a restraint bar with added padding, in the at-rest condition,

FIG. 13 a side view of restraint bar with added padding, in the activated condition,

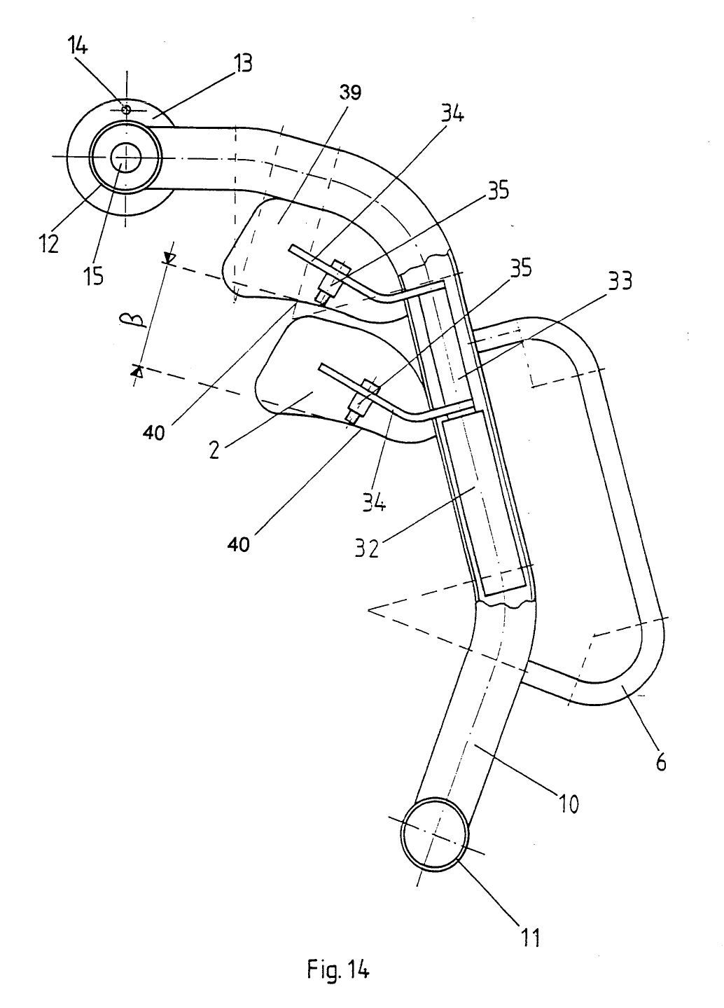

FIG. 14 a side view with vertically displaceable auxiliary bars.

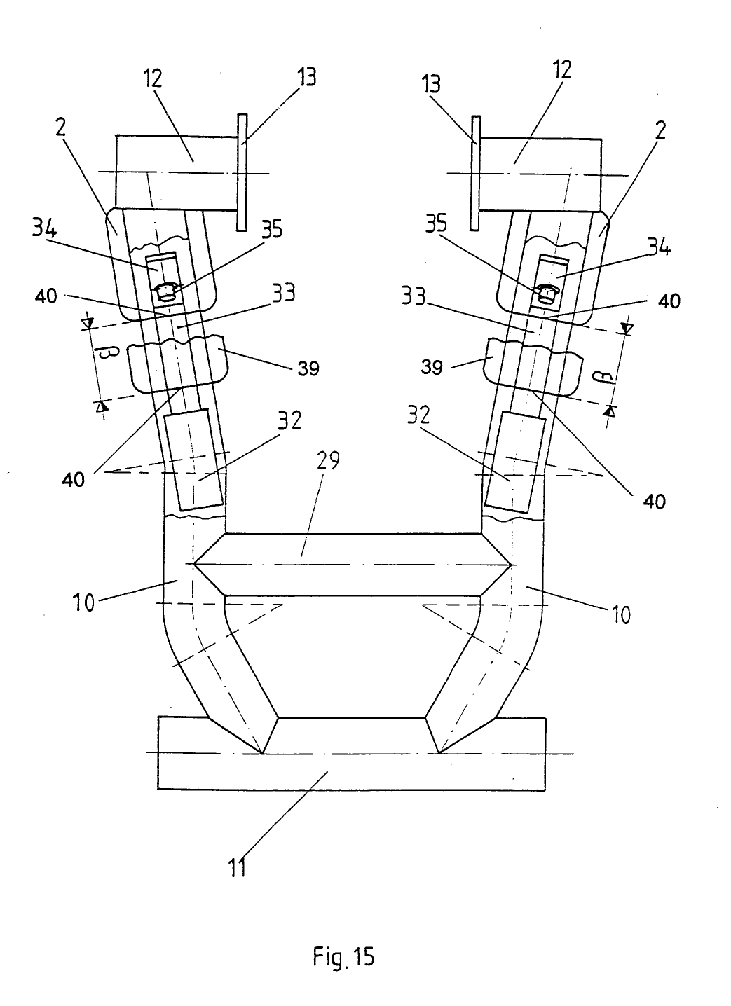

FIG. 15 a rear view with vertically displaceable auxiliary bars,

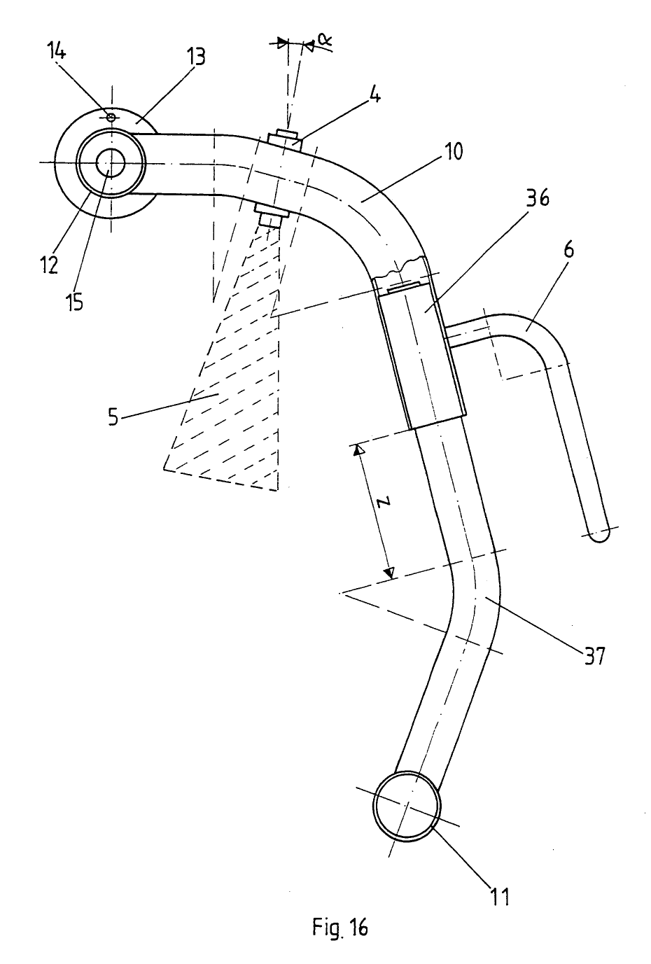

FIG. 16 a side view of a restraint bar with telescopically insertable transverse arm section,

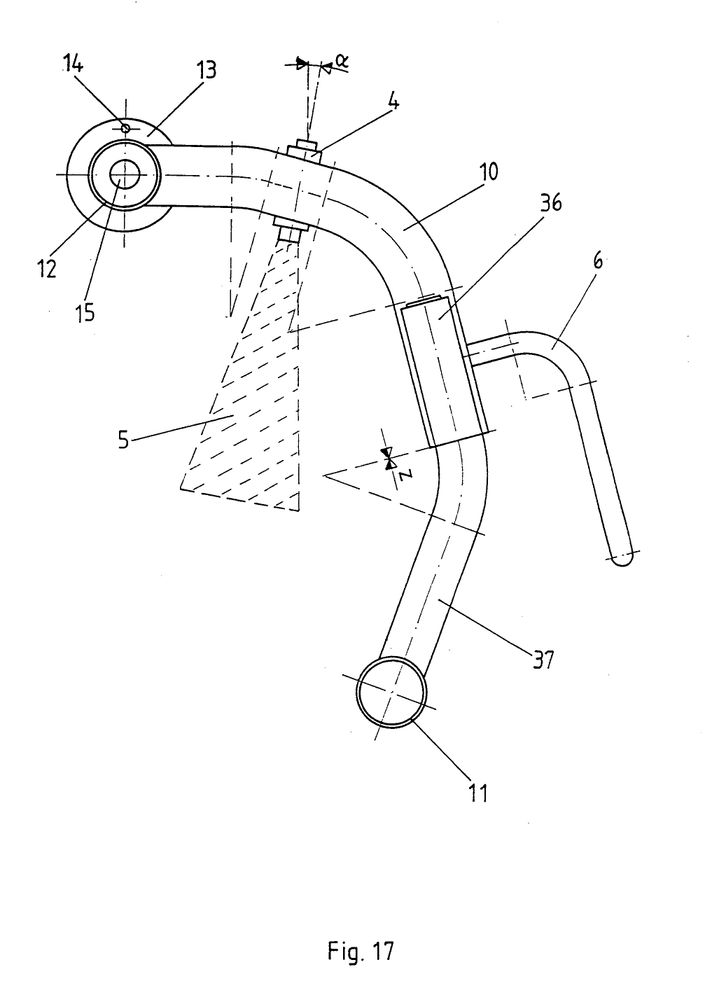

FIG. 17 a view of FIG. 16 with inserted transverse arm section,

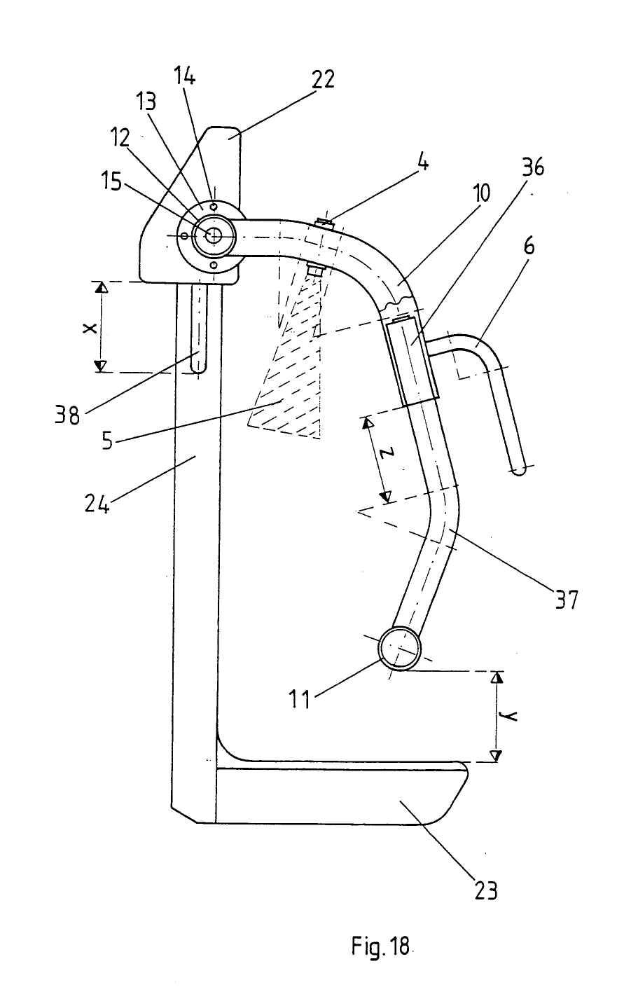

FIG. 18 a view of a seat with restraint bar, and

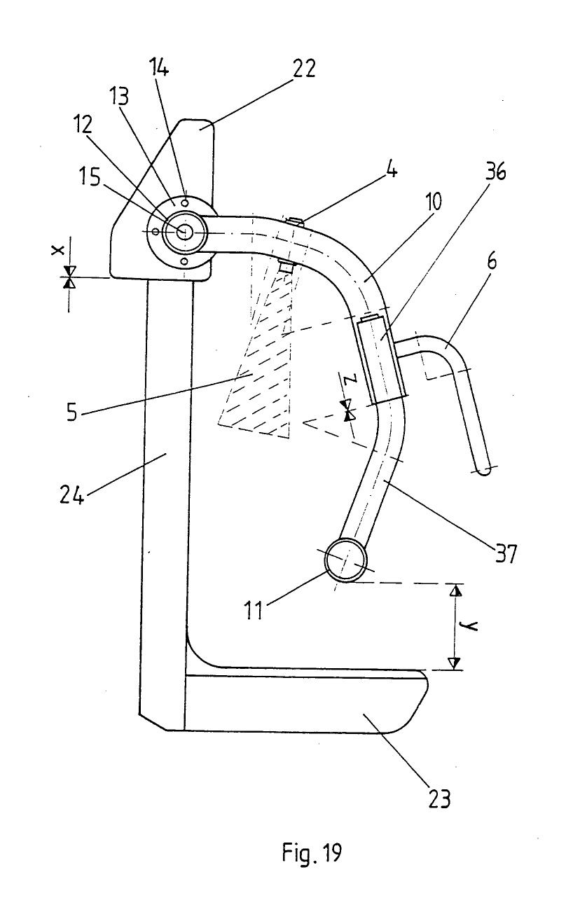

FIG. 19 a view of FIG. 18 with an inserted transverse arm section.

In the view represented in FIG. 1, the restraint bar is represented in a partial cross section side view.

The restraint bar is constructed as a U-shaped frame whose free arm ends are journaled to the seat on both sides of the head area of the seat over axial support pieces 12. FIG. 1 shows a support bar 10 structured as an arm on whose underside is attached a transverse arm as a transverse support bar 11.

The bar is rotatably journaled in an amusement contrivance via the flange boring 15 at the top of a usual type seat. Assembly follows via a mounting flange 13 attached to the seat with screws by way of the threaded holes 14. Supply of energy to the restraint bar can be accomplished over energy supply lines that are guided through a bar support boring 16.

Located on the support bars 10, on the side of the restraint bar lying opposite the person, is a handle 6 that optionally includes an energy connection 7 over which can be supplied an electrical current for heating the handle, especially in the cold season.

Practically the entire restraint bar is surrounded by a basic padding that is formed, in particular, of closed-pore sponge rubber. Constructed on the side of the restraint bar adjacent to the person is an air chamber 19 that can be inflated to render possible a further improved padding. The contact surface 20 of the air chamber 19 thus lies tightly against the body of the user. Provision can also be made for the air chamber 19 to be inflated only after closing the bar so that a still better fitting to the shape of the person to be secured becomes possible. Provided for this in an air nozzle fixture 8 are air nozzles 9, via which, after closure of the restraint bar, air can be supplied at a particular air pressure to the air chamber 19.

According to the invention, located on the restraint bar, and actually on both sides of the longitudinal arm of the restraint bar, namely on the support bars 10, is a guide cylinder 1 that is embodied arc-shaped, and in the at-rest condition does not project from the plane of the restraint bar. The guide cylinder 1 is made in somewhat the form of a quarter circle. FIG. 1 shows the extended condition of the auxiliary bar 2 with its contact surface 17. The out- and in-travel is pneumatically controlled over the control connection 3. In the extended condition of the auxiliary bar 2 this latter finds itself in a plane below the shoulder plane of the restraint bar and runs approximately parallel to the shoulder section of the restraint bar. Hence it forms a shoulder support surface for smaller persons. The auxiliary bar 2 consists of two arc-shaped piston rods that are telescopically retractable into the guide cylinder 1 and extendible out from the guide cylinder 1.

Extension of the auxiliary bar 2 formed on the lateral piston rods can occur only when one or several measurement sensors 4 disposed in the shoulder area of the restraint bar determine that there is no object below the shoulder area at a certain distance from the measurement sensor. The measurement beam 5 is represented in broken lines and indicates the reacting sensor area of the measurement sensor 4. Hence, when a person is within the measurement beam 5 of the shoulder area after the restraint bar would have been closed, the measurement sensor 4 emits a corresponding signal so that, in this case, the auxiliary bar remains in its basic condition. If after closure of the restraint bar there is no object in the measurement beam 5 of the sensor 4, i.e. in particular not the shoulder of a person, control connection 3 of the auxiliary bar 2 is activated, so that the auxiliary bar 2 is extended out from the guide cylinder 1.

The adjustment angle α of the measurement sensor 4 determines the spread of the measurement beam 5 as well as its depth of detection, The suitable adjustment angle α is, in particular, to be established experimentally. The length of the guide cylinder 1 and its active angle γ also determine the length of the auxiliary bar 2 and its angle of movement β. Further provision can be made that the guide cylinder 1 be kept relatively short, and also that in the at-rest condition part of the auxiliary bar 2 extends out from the guide cylinder 1, with the projecting end being provided with padding so that this additional padding increases comfort even in the case of small persons. Provision can also be made to equip the auxiliary bar 2 with a bellows-type covering, which, when extending the auxiliary bar, will be placed under air pressure in order to be able to furnish the entire length of the auxiliary bar with padding.

FIG. 2 shows the restraint bar in a front view. The figure shows clearly attachment of the restraint bar over the axial support piece 12 and the mounting flange 13. The restraint bar is constructed as a U-shaped frame, whereby the lateral arms are formed by the support bar 10, and the transverse arm by the transverse support bar 11. For increasing stiffness, another transverse frame 29 is disposed between the support bars 10.

FIG. 2 also clearly shows that the basic padding 18 includes not only the longitudinal and transverse arms of the frame, but in particular also the entire section between the transverse frame 29 and the transverse support bar 11.

FIG. 3 shows the rear view of the restraint bar. Shown clearly here are the guide cylinder 1 and the two rod-shaped auxiliary bars 2.

FIG. 4 shows the restraint bar in the in-use condition where a large person 21 is being held. The person's shoulder props itself against the shoulder section of the restraint bar. The breast side of the person lies close to the front side of the restraint bar. The underside of the restraint bar is located in the buttocks area of the person. Hence, the person is supported in all essential areas.

FIG. 4 also clearly shows that the auxiliary bar 2 is in the retracted condition. Release of the auxiliary bar would be prevented by the fact that the measurement sensor 4 has determined that the shoulder area of the person is located directly below the measurement sensor 4.

FIG. 5 shows a corresponding representation for a small person 25. With like equipped seat 23, head rest 22 and center support rack 24, the person is, in particular, held by the extended auxiliary bar 2. Since in the case of a small person 25, especially in the case of children, there can be present an open space between the center support rack 24 and the back of the person, provision can also be made that the swingable section of the restraint bar is increased somewhat more when the auxiliary bar 2 is extended in the direction of the center support rack 24, in order thereby to better press the person against the center support rack.

It is also possible to equip the center support rack 24 with an inflatable padding that presses the small person 25 against the restraint bar. In this way it is possible to achieve a structure that provides additional head support, since as a rule the small person 25 does not reach to the head rest 22.

FIG. 6 shows an alternative form of execution of the auxiliary bar 2. This letter, instead of being supported in a telescoping cylinder 1 is journaled on a swiveling axle 26, and can be swung about the angle of movement β. The auxiliary bar 2 can be constructed straight, as represented, or also arc-shaped in order to be fitted to the shoulders of the user. In this form of execution the padding is embodied in more simple fashion than in the first form of execution.

FIG. 7 shows an auxiliary bar 2 that is executed as a pressure plate that is pressed against the smaller person via guide pistons 28. Actuation of the guide pistons 28 is accomplished via control cylinder 27. Extension proceeds in the same way as in the other forms of execution, in particular by interpretation of the sensor signal from the measurement sensor.

FIG. 8 shows an alternative form of execution related to 7, where the measurement sensor is located in the front section of the restraint bar. Here, the contact pressure plate is located in the shoulder area of the restraint bar, so that the contact pressure on the shoulders of the smaller user can occur from above.

FIG. 9 shows a cross section view of the arms of the restraint bar. Shown as basic padding is a high-resistance foam padding 18, which surrounds the entire tube, and that is provided on the side lying against the person with an air chamber 19 that forms a front side contact surface toward the person 21.

FIG. 10 shows the inflated condition of the air chamber 19 whose contact surface touches the large person 21 Under presumption of a sufficient air pressure in the air chamber 19, the person is, therewith, better padded and, in particular, additionally stabilized in the seat.

In an alternative, non-represented embodiment of the invention, the auxiliary bar is attached to the center support rack 24, and in particular, in recesses of the seat cushion. By actuating the auxiliary bar it will be guided onto the shoulders from the rear of the person.

FIG. 11 shows a restraint bar where a pneumatic cylinder 30 is arranged in the shoulder section of the bar.

Extendible out from the cylinder 30, over the distance φ, is a piston 31 that carries at its free end a non-represented pressure cushion. The cylinder 30 is activated simultaneously with actuation of the auxiliary bar, so that the shoulder area of a child, while riding, will be padded toward the front/top. The pressure cushion can act directly on the shoulder area of a child; however, it can also form a lateral support for the head.

FIG. 12 shows a restraint bar where the cushion 19 is equipped with an additional air chamber that is inflatable simultaneously with actuation of the auxiliary bar.

The at-rest position of the additional air chamber is shown in FIG. 12, while the inflated position can be seen in FIG. 13. In this construction also, especially additionally protected is the head/shoulder area of a child.

FIG. 14 shows an execution where a telescoping cylinder 32 is arranged in a longitudinal arm of the restraint bar and attached to it.

Extendible out from the telescoping cylinder 32 is the guide piston 33 that carries at its free end a transverse rod 34 that is surrounded by a pressure cushion 39, whose contact surface is designated with the numeral 40.

By extending and retracting the guide piston 33 it is possible to displace the pressure cushion by the distance β, so that adaptation of the restraint bar to smaller persons is achievable.

The pressure cushions 39 display pressure sensors 35 through which the pressing fore of the contact surface 40 can be regulated, by using the control signal from the pressure sensors for adjusting the extension height of the guide piston 33.

The cylinder 32 can also be attached to the restraint bar in the reverse direction, so that the cushion 39 can be brought into a lowered position by extending the guide piston.

FIG. 15 shows a rear view of the arrangement of FIG. 14.

It becomes clear that the cylinders 30 can each actuate one cushion. Preferably, the cushions or the cylinders 30 are actuated synchronously.

FIG. 16 shows a form of execution where the transverse support bar 11 together with the lower arm parts 37 of the multiple-part-constructed restraint bar forms a transverse arm section that is displaceable in the vertical direction.

FIG. 17 shows the retracted condition of the transverse arm section.

FIG. 18 makes clear the function of the displaceable transverse arm section in cooperation with a possibility of swinging the entire restraint bar in the vertical direction with respect to the seat. Additionally, the swivel joint accommodating the restraint bar can be displaced in the vertical direction along the guide rail 38 by the amount of the distance X.

With an appropriate vertical movement of the restraint bar downwardly by the amount of the distance X, which is controlled by the signal of the distance sensor 4, the transverse arm section is synchronously displaced upwardly by the amount of the distance Z, so that the distance Y of the transverse arm section from the seat remains nearly constant.

FIG. 19 shows a correspondingly downwardly displaced restraint bar that, in this condition, is suitable for small persons.

### Reference Number List

1. Guide cylinder

2. Auxiliary bar

3. Control connection

4. Measurement sensor

5. Measurement beam

6. Hand grip, handle

7. Energy connection

8. Air nozzle fixture

9. Air nozzle

10. Support bar

11. Transverse support bar

12. Axial support piece

13. Mounting flange

14. Threaded boring

15. Flange boring

16. Support bar boring

17. Contact surface

18. Basic padding

19. Air chamber

20. Contact surface

21. large person

22. Head support

23. Seat

24. Center support rack

25. Small person

26. Axis of rotation

27. Control cylinder

28. Guide piston

29. Transverse frame

30. Pneumatic cylinder

31. Piston

32. Cylinder

33. Guide piston

34. Transverse rod

35. Pressure sensor

36. Telescoping cylinder

37. Lower arm part

38. Guide rail

39. Pressure cushion

40. Contact surface

1. Restraint bar for securing a person in vehicles, especially amusement rides, which is supported in a swivel joint on the head end of a seat, whereby the and of the restraint bar lying opposite the swivel joint is upwardly swingable for a person to board and to alight, and is lowerable for securing the person on the shoulder and breast side, characterized by the fact that associated with the restraint bar are one or two auxiliary bars (2), which, on the one hand, are attached to the restraint bar and, on the other hand, on their free end can be introduced into a plane below the shoulder side area of the restraint bar.

2. Restraint bar according to claim 1, characterized by the fact that the restraint bar is constructed as a U-shaped frame whose free ends are supported in the swivel joint on either side of the head area of the seat.

3. Restraint bar according to claim 1 or 2, characterized by the fact that the auxiliary bars (2) contain two telescoping guides with extendible rods that are attached to the arms of the restraint bar.

4. Restraint bar according to claim 3, characterized by the fact that the telescoping guides and extendible rods are constructed arc-shaped, whereby in the retracted condition they are essentially parallel to the arms of the U-shaped frame, and in the extended condition form a plane below the shoulder side section of the restraint bar, in order, in this way, to construct a shoulder support for smaller persons.

5. Restraint bar according to claim 2, characterized by the fact that the auxiliary bars (2) are constructed as two-armed pivoting bars disposed on either side of the seat, which are attached on the restraint bar by means of a swivel joint (26), and that the free arm of the pivoting bars in the extended condition form a plane below the shoulder side section of the restraint bar, in order thereby to construct a shoulder support for smaller persons.

6. Restraint bar according to claim 2, characterized by the fact that the auxiliary bars contain telescoping guides attached to the restraint bar, with telescoping rods extendible parallel to the longitudinal arm of the restraint bar, which rods, on their free ends, display pressure cushions directed in the direction of the back side of the seat, which by lowering the telescoping rods can be lowered into a plane below the shoulder side section of the restraint bar.

7. Restraint bar according to claim 6, characterized by the fact that the pressure cushions are attached to transverse rods that are connected with the free ends of the telescoping rods.

8. Restraint bar for securing a person in vehicles, especially amusement rides, which on the head end of a seat is supported in a swivel joint, whereby the end of the restraint bar lying opposed to the swivel joint is upwardly swingable for a person to board and to alight, and is lowerable for securing the person on the shoulder and breast side, characterized by the fact that the restraint bar is constructed of multiple parts, whereby the transverse arm section (11) in the lowered condition is displaceable in the vertical direction.

9. Restraint bar according to claim 8, characterized by the fact that the transverse arm section (11) is coupled with the longitudinal arm of the restraint bar via a telescoping connection.

10. Restraint bar according to claim 8 or 9, characterized by the fact that displacement of the restraint bar can be executed synchronously with an opposite displacement of the transverse arm section.

11. Restraint bar according to one of the preceding claims, characterized by the fact that its U-shaped frame is provided in the transverse arm section with a pressure cushion (19) and that at least the side of the frame facing toward the person is equipped with a cushioning pad (19).

12. Restraint bar according to claim 11, characterized by the fact that the auxiliary bars are also equipped with a cushioning pad.

13. Restraint bar according to claim 11 or 12, characterized by the fact that the cushions are constructed as fluid-filled hollow chambers.

14. Restraint bar according to claim 13, characterized by the fact that the fluid is a viscous gel.

15. Restraint bar according to one of the preceding claims, characterized by the fact that the U-shaped frame displays an arc-shaped gripping bar (6) facing toward the person.

16. Restraint bar according to claim 15, characterized by the fact that the gripping bar (6) is electrically heated.

17. Restraint bar according to one of claims 1-7, characterized by the fact that actuation of the auxiliary bars is accomplished pneumatically.

18. Restraint bar according to one of claims 8-10, characterized by the fact that displacement of the swivel joint and/or of the transverse arm section is done pneumatically.

19. Restraint bar according to one of claims 1-7, 17 or 18, characterized by the fact that arranged in the shoulder section of the restraint bar is at least one distance sensor (4) which, upon determining that the shoulder height of the person is below the set point height value, triggers a control signal for actuation of the auxiliary bar or displacement of the restraint bar and/or the transverse arm section.

20. Restraint bar according to claim 19, characterized by the fact that the sensor is a capacitive sensor.

21. Restraint bar according to one of claims 18-20, characterized by the fact that with release of the restraint bar out of the locked position the auxiliary bars or the transverse arm section can also be returned into the at-rest position.

22. Restraint bar according to the precharacterizing clause of claim 1, characterized by the fact that associated with the restraint bar is a support bar which, on the one hand, is attached to the back side of the seat and, on the other hand, with its free end is insertable into a plane below the shoulder side section of the restraint bar.

23. Restraint bar according to one of the preceding claims, characterized by the fact that when actuating the auxiliary bar or the transverse arm section additional padding on the seat is capable of being activated for further support of the head/shoulder area of a person.

24. Passenger seat for an amusement device with auxiliary arms for securing a person according to one or more of claims 1-23.
